(19) United States
(12) Patent Application Publication
(10) Pub. No.: US 2021/0229466 A1
(43) Pub. Date: Jul. 29, 2021

(54) METHOD OF PRINTING

(71) Applicant: Tetra Laval Holdings & Finance S.A., Pully (CH)

(72) Inventors: Daniel Cederström, Limhamn (SE); Abolghasem Shourvarzi, Malmö (SE); Jon Harper-Smith, Burwash (GB); Sarah Canning, Ramsgate (GB); Jeremy Ward, Broadstairs (GB)

(21) Appl. No.: 17/012,628

(22) Filed: Sep. 4, 2020

(30) Foreign Application Priority Data
Jan. 28, 2020 (GB) 2001143.3

(51) Int. Cl. B41J 11/00; B41J 2/21; B41M 7/00

(52) U.S. Cl. CPC B41J 11/002; B41M 7/009; B41J 2/2107

(57) ABSTRACT

A method of inkjet printing can include providing an inkjet ink comprising a radiation-curable material, inkjet printing the inkjet ink onto one or more substrates to produce one or more substrates having a printed surface and an unprinted surface, curing the printed surface of the one or more substrates by exposure to a source of actinic radiation and/or a first source of low-energy electron beam radiation, storing the one or more substrates such that the printed surface of the one or more substrates is in contact with the unprinted surface of the one or more substrates, and separating the printed and unprinted surfaces of the one or more substrates and sterilising the one or more substrates by exposure to a second source of low-energy electron beam radiation.

### TECHNICAL FIELD

This disclosure relates to a method of printing and in particular to a method of printing an inkjet ink. The method of printing is suitable for food packaging applications.

### DESCRIPTION OF THE RELATED ART

In inkjet printing, minute droplets of black, white or coloured ink are ejected in a controlled manner from one or more reservoirs or printing heads through narrow nozzles on to a substrate which is moving relative to the reservoirs. The ejected ink forms an image on the substrate.

For high-speed printing, the inks must flow rapidly from the printing heads, and, to ensure that this happens, they must have in use a low viscosity, typically 200 mPas or less at 25° C., although in most applications the viscosity should be 50 mPas or less, and often 25 mPas or less. Typically, when ejected through the nozzles, the ink has a viscosity of less than 25 mPas, preferably 5-15 mPas and most preferably between 7-11 mPas at the jetting temperature which is often elevated to, but not limited to 40-50° C. (the ink might have a much higher viscosity at ambient temperature). The inks must also be resistant to drying or crusting in the reservoirs or nozzles. For these reasons, inkjet inks for application at or near ambient temperatures are commonly formulated to contain a large proportion of a mobile liquid vehicle or solvent such as water or a low-boiling solvent or mixture of solvents.

Another type of inkjet ink contains unsaturated organic compounds, termed monomers and/or oligomers which polymerise when cured. This type of ink has the advantage that it is not necessary to evaporate the liquid phase to dry the print; instead the print is cured, a process which is more rapid than evaporation of solvent at moderate temperatures.

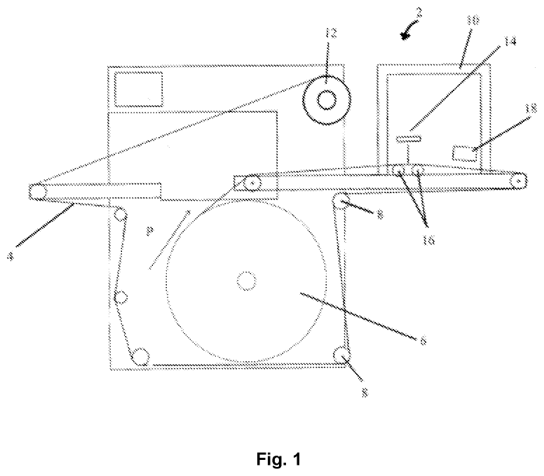

Reel-to-reel printing places particular demands on the inkjet ink. FIG. 1 shows a reel-to-reel printer 2. A substrate 4 is tightly wound on a substrate reel 6. The substrate reel 6 is caused to move in order to deliver the substrate 4, via guide reels 8, to the inkjet printing station 10. The substrate 4 moves in the print direction P shown by the arrow. At the printing station 10, the ink is applied by printhead 14 shown schematically in FIG. 1. The stabilising reels 16 are positioned to provide a stable web onto which the ink is applied. As the substrate passes through the printing station 10, the ink is cured by a UV drier 18. The substrate 4 is subsequently accumulated on the receiving reel 12.

Reel-to-reel printing is a continuous process and therefore the substrate, and hence the ink printed thereon, only makes one pass under the radiation source, i.e. reel-to-reel printing is a single pass application. This results in the ink receiving a low dose of radiation, but at the same time the ink must cure quickly because of the speed at which the substrate travels from reel to reel.

A consequence of reel-to-reel printing is that the substrate 4 is gathered on the receiving reel 12. The accumulation of layer upon layer of printed substrate causes significant temperatures and pressures to develop in the receiving reel and, as a result, there can be a problem of so-called offset migration, i.e. where species from the print are transferred onto the unprinted side of the substrate 4 as the receiving reel 12 is unwound. Avoidance of offset migration is therefore essential in reel-to-reel printing inks.

It has also been found that the same problem occurs in automated and semi-automated printing processes using a flat-bed inkjet printer where the substrate is loaded into the printer and the printer then prints and stacks the printed substrates upon one another. With automated processes, a significant pressure may build up under the weight of the printed substrates. Again, avoidance of offset migration is therefore essential in printing inks designed for automated and semi-automated processes.

Offset migration can be particularly problematic in food packaging applications where it can ultimately lead to contamination of the foodstuff. In this respect, food packaging represents a particular challenge on account of the strict safety limitations on the properties of materials which come into contact with food, including indirect additives like packaging inks. For printed food packaging, it is necessary to control and quantify the migration of the components of the printed image on the food packaging into the food products. Many components readily used for inkjet inks, including volatile organic solvents, many monomers and photoinitiators, cannot be used for printing onto food packaging because of their migration properties. However, such components are often needed to meet the requirements for inkjet printing.

There are therefore a number of competing factors when considering methods of inkjet printing such as reel-to-reel printing and other printing processes where offset migration may be an issue, particularly for food packaging applications. There remains a need in the art for a method of inkjet printing which maintains the benefits of processes such as reel-to-reel printing but minimises the amount of migratable species on the printed substrate, without compromising the properties of the ink.

### SUMMARY

Accordingly, some embodiments provide a method of inkjet printing comprising the following steps, in order:

(i) providing an inkjet ink comprising a radiation-curable material;
(ii) inkjet printing the inkjet ink onto one or more substrates to produce one or more substrates having a printed surface and an unprinted surface;
(iii) curing the printed surface of the one or more substrates by exposure to a source of actinic radiation and/or a first source of low-energy electron beam radiation;
(iv) storing the one or more substrates such that the printed surface of the one or more substrates is in contact with the unprinted surface of the one or more substrates; and
(v) separating the printed and unprinted surfaces of the one or more substrates and sterilising the one or more substrates by exposure to a second source of low-energy electron beam radiation.

Previously, it had not been appreciated that the sterilising step in aseptic packaging processes affects the amount of migratable species on the printed substrate. In some embodiments, the inventors have found that sterilising a substrate using electron beam radiation, where the substrate has been printed with a radiation-curable inkjet ink and stored such that a printed surface of the substrate is in contact with an unprinted surface of the substrate, has the advantage of reducing the amount of migratable species that has transferred to the unprinted surface of the substrate during offset migration. This is particularly useful for food packaging applications.

### BRIEF DESCRIPTION OF THE DRAWINGS

The present disclosure will now be described with reference to the drawing, in which FIG. 1 shows a printer for reel-to-reel printing.

### DETAILED DESCRIPTION

Some embodiments are directed primarily to a method of inkjet printing suitable for use in reel-to-reel printing and with the printer described hereinabove with reference to FIG. 1.

In accordance with some embodiments, the method comprises: (i) providing an inkjet ink comprising a radiation-curable material.

The radiation-curable material is not particularly limited and the formulator is free to include any such radiation-curable material in the ink of some of the embodiments to improve the properties or performance of the ink. This radiation-curable material can include any radiation-curable material readily available and known in the art in inkjet inks. By “radiation-curable” is meant a material that polymerises and/or crosslinks upon irradiation, for example, when exposed to actinic radiation, in the presence of a photoinitiator.

The amount of radiation-curable material is not limited other than by the constraints imposed by the use in an inkjet ink, such as viscosity, stability, toxicity etc. In a preferred embodiment, the inkjet ink comprises 20 to 95% by weight of radiation-curable material, based on the total weight of the ink.

In a preferred embodiment, the inkjet ink comprises radiation-curable material that is suitable for printing onto food packaging.

In a preferred embodiment, the inkjet ink comprises a radiation-curable monomer. As is known in the art, monomers may possess different degrees of functionality, which include mono, di, tri and higher functionality monomers.

In a preferred embodiment, the inkjet ink comprises a di- and/or multifunctional radiation-curable monomer.

For the avoidance of doubt, mono and difunctional are intended to have their standard meanings, i.e. one or two groups, respectively, which take part in the polymerisation reaction on curing. Multifunctional (which does not include difunctional) is intended to have its standard meaning, i.e. three or more groups, respectively, which take part in the polymerisation reaction on curing.

In a preferred embodiment, the radiation-curable monomer is a di-, tri-, tetra-, penta- or hexa-functional monomer, i.e. the radiation curable monomer has two, three, four, five or six functional groups. In a particularly preferred embodiment, the inkjet ink comprises a difunctional monomer. In a particularly preferred embodiment, the inkjet ink comprises at least two di- and/or multifunctional radiation-curable monomers and more preferably, at least two difunctional monomers.

The functional group of the di- and/or multifunctional radiation-curable monomer, which is utilised in the ink of some embodiments may be the same or different but must take part in the polymerisation reaction on curing. Examples of such functional groups include any groups that are capable of polymerising upon exposure to radiation and are preferably selected from a (meth)acrylate group and a vinyl ether group.

The di- and/or multifunctional radiation-curable monomer may possess different degrees of functionality, and a mixture including combinations of di, tri and higher functionality monomers may be used.

The substituents of the di- and/or multifunctional radiation-curable monomer are not limited other than by the constraints imposed by the use in an ink-jet ink, such as viscosity, stability, toxicity etc. The substituents are typically alkyl, cycloalkyl, aryl and combinations thereof, any of which may be interrupted by heteroatoms. Non-limiting examples of substituents commonly used in the art include C₁₋₁₈ alkyl, C₃₋₁₈ cycloalkyl, C₆₋₁₀ aryl and combinations thereof, such as C₆₋₁₀ aryl- or C₃₋₁₈ cycloalkyl-substituted C₁₋₁₈ alkyl, any of which may be interrupted by 1-10 heteroatoms, such as oxygen or nitrogen, with nitrogen further substituted by any of the above described substituents. The substituents may together also form a cyclic structure.

In a preferred embodiment, the inkjet ink comprises 5 to 90% by weight of a di- and/or multifunctional radiation-curable monomer, based on the total weight of the ink.

Examples of the di- and/or multifunctional radiation-curable monomer include difunctional (meth)acrylate monomers, multifunctional (meth)acrylate monomers, divinyl ether monomers, multifunctional vinyl ether monomers and di- and/or multifunctional vinyl ether (meth)acrylate monomers. Mixtures of di- and/or multifunctional radiation-curable monomer may also be used.

In a preferred embodiment, the radiation-curable material comprises a (meth)acrylate monomer, more preferably a di- and/or multifunctional (meth)acrylate monomer. In a particularly preferred embodiment, the inkjet ink comprises a difunctional (meth)acrylate monomer.

For the avoidance of doubt, (meth)acrylate is intended herein to have its standard meaning, i.e. acrylate and/or methacrylate.

Difunctional (meth)acrylate monomers are well known in the art and a detailed description is therefore not required. Examples include hexanediol diacrylate (HDDA), 1,8-octanediol diacrylate, 1,9-nonanediol diacrylate, 1,10-decanediol diacrylate (DDDA), 1,11-undecanediol diacrylate and 1,12-dodecanediol diacrylate, polyethylene glycol diacrylate (for example tetraethylene glycol diacrylate, PEG200DA, PEG300DA, PEG400DA, PEG600DA), dipropylene glycol diacrylate (DPGDA), tripropylene glycol diacrylate (TPGDA), tricyclodecane dimethanol diacrylate (TCDDMDA), neopentylglycol diacrylate, 3-methyl-1,5-pentanediol diacrylate (3-MPDDA), and the acrylate esters of ethoxylated or propoxylated glycols and polyols, for example, propoxylated neopentylglycol diacrylate (NPGPODA), and mixtures thereof. Also included are esters of methacrylic acid (i.e. methacrylates), such as hexanediol dimethacrylate, 1,8-octanediol dimethacrylate, 1,9-nonanediol dimethacrylate, 1,10-decanediol dimethacrylate, 1,11-undecanediol dimethacrylate and 1,12-dodecanediol dimethacrylate, triethyleneglycol dimethacrylate, diethyleneglycol dimethacrylate, ethyleneglycol dimethacrylate, 1,4-butanediol dimethacrylate and mixtures thereof. 3-MPDDA is particularly preferred.

Preferably, the inkjet ink comprises 5 to 70% by weight, more preferably 25-70% by weight, more preferably 40-70% by weight and most preferably 45-70% by weight of a difunctional (meth)acrylate monomer, based on the total weight of the ink. However, for some applications, the amount present may be higher and in such a preferred embodiment, the ink comprises up to 80% by weight of a difunctional (meth)acrylate monomer, based on the total weight of the ink.

The inkjet ink may comprise a multifunctional (meth)acrylate monomer.

Suitable multifunctional (meth)acrylate monomers (which do not include difunctional (meth)acrylate monomers) include tri-, tetra-, penta-, hexa-, hepta- and octa-functional monomers. Examples of the multifunctional acrylate monomers that may be included in the inkjet inks include trimethylolpropane triacrylate, dipentaerythritol triacrylate, tri(propylene glycol) triacrylate, bis(pentaerythritol) hexaacrylate, and the acrylate esters of ethoxylated or propoxylated glycols and polyols, for example, ethoxylated trimethylolpropane triacrylate and ethoxylated pentaerythritol tetraacrylate (EOPETTA, also known as PPTTA), and mixtures thereof. Suitable multifunctional (meth)acrylate monomers also include esters of methacrylic acid (i.e. methacrylates), such as trimethylolpropane trimethacrylate. Mixtures of (meth)acrylates may also be used.

The amount of the multifunctional (meth)acrylate monomer, when present, is preferably 5-25% by weight, based on the total weight of the ink.

The di- and/or multifunctional radiation-curable monomer may have at least one vinyl ether functional group.

In a preferred embodiment, the inkjet ink comprises a divinyl ether monomer, a multifunctional vinyl ether monomer, a divinyl ether (meth)acrylate monomer and/or a multifunctional vinyl ether (meth)acrylate monomer. In a particularly preferred embodiment, the inkjet ink comprises a divinyl ether monomer.

Examples of a divinyl ether monomer include triethylene glycol divinyl ether (DVE-3), diethylene glycol divinyl ether, 1,4-cyclohexanedimethanol divinyl ether, bis[4-(vinyloxy)butyl] 1,6-hexanediylbiscarbamate, bis[4-(vinyloxy)butyl] isophthalate, bis[4-(vinyloxy)butyl] (methylenedi-4,1-phenylene)biscarbamate, bis[4-(vinyloxy)butyl] succinate, bis[4-(vinyloxy)butyl]terephthalate, bis[4-(vinyloxymethyl)cyclohexylmethyl] glutarate, 1,4-butanediol divinyl ether and mixtures thereof.

Triethylene glycol divinyl ether (DVE-3) is particularly preferred. DVE-3 is preferred because of its low viscosity. It has a lower viscosity than the equivalent acrylate monomer because the vinyl ether groups have fewer polar interactions than acrylates but vinyl ether groups are less reactive than acrylates on exposure to UV radiation. However, this lower reactivity can lead to unreacted DVE-3 molecules which are prone to offset migration. As discussed below, the ebeam sterilisation step of the method of 15 some of the embodiments reduces the amount of unreacted and migratable DVE-3 for food packaging applications.

An example of a multifunctional vinyl ether monomer is tris[4-(vinyloxy)butyl] trimellitate.

Examples of a vinyl ether (meth)acrylate monomer include 2-(2-vinyloxy ethoxy)ethyl acrylate (VEEA), 2-(2-vinyloxy ethoxy)ethyl methacrylate (VEEM) and mixtures thereof.

In a preferred embodiment, the di- and/or multifunctional radiation-curable monomer is selected from 1,10-decanediol diacrylate (DDDA), hexanediol diacrylate (HDDA), polyethylene glycol diacrylate, tripropylene glycol diacrylate (TPGDA), 3-methyl 1,5-pentanediol diacrylate (3-MPDDA), dipropylene glycol diacrylate (DPGDA), tricyclodecane dimethanol diacrylate (TCDDMDA), propoxylated neopentyl glycol diacrylate (NPGPODA), trimethylolpropane triacrylate (TMPTA), di-trimethylolpropane tetraacrylate (DiTMPTA), di-pentaerythritol hexaacrylate (DPHA), ethoxylated trimethylolpropane triacrylate (EOTMPTA), ethoxylated pentaerythritol tetraacrylate (EOPETTA), triethylene glycol divinyl ether (DVE-3) and mixtures thereof.

For food packaging applications, the di- and/or multifunctional radiation-curable monomer is preferably selected from 1,10-decanediol diacrylate (DDDA), ethoxylated (5) hexanediol diacrylate (HD(EO)DA), polyethylene glycol (600) diacrylate (PEG600DA), tripropylene glycol diacrylate (TPGDA), 3-methyl 1,5-pentanediol diacrylate (3-MPDDA), tricyclodecane dimethanol diacrylate (TCDDMDA), propoxylated neopentyl glycol diacrylate (NPGPODA), di-trimethylolpropane tetraacrylate (DiTMPTA), di-pentaerythritol hexaacrylate (DPHA), ethoxylated trimethylolpropane triacrylate (EOTMPTA), ethoxylated pentaerythritol tetraacrylate (EOPETTA), triethylene glycol divinyl ether (DVE-3) and mixtures thereof.

In a preferred embodiment, the difunctional monomer, when present, is selected from 1,10-decanediol diacrylate (DDDA), hexanediol diacrylate (HDDA), polyethylene glycol diacrylate, tripropylene glycol diacrylate (TPGDA), 3-methyl 1,5-pentanediol diacrylate (3-MPDDA), dipropylene glycol diacrylate (DPGDA), tricyclodecane dimethanol diacrylate (TCDDMDA), propoxylated neopentyl glycol diacrylate (NPGPODA), triethylene glycol divinyl ether (DVE-3) and mixtures thereof.

For food packaging applications, the difunctional monomer, when present, is preferably selected from 1,10-decanediol diacrylate (DDDA), ethoxylated (5) hexanediol diacrylate (HD(EO)DA), polyethylene glycol (600) diacrylate (PEG600DA), tripropylene glycol diacrylate (TPGDA), 3-methyl 1,5-pentanediol diacrylate (3-MPDDA), tricyclodecane dimethanol diacrylate (TCDDMDA), propoxylated neopentyl glycol diacrylate (NPGPODA), triethylene glycol divinyl ether (DVE-3) and mixtures thereof.

Preferably, the difunctional monomer, when present, comprises 3-methyl 1,5-pentanediol diacrylate (3-MPDDA) and triethylene glycol divinyl ether (DVE-3). More preferably, 3-methyl 1,5-pentanediol diacrylate (3-MPDDA) and triethylene glycol divinyl ether (DVE-3) are the sole difunctional monomers present in the ink.

Monomers typically have a molecular weight of less than 600, preferably more than 200 and less than 450. Monomers are typically added to inkjet inks to reduce the viscosity of the inkjet ink. They therefore preferably have a viscosity of less than 150 mPas at 25° C., more preferably less than 100 mPas at 25° C. and most preferably less than 20 mPas at 25° C. Monomer viscosities can be measured using an ARG2 rheometer manufactured by T.A. Instruments, which uses a 40 mm oblique/2° steel cone at 25° C. with a shear rate of 25 s⁻¹.

In a preferred embodiment, the inkjet ink may further comprise a monofunctional monomer, such as a monofunctional (meth)acrylate monomer.

Monofunctional monomers are well known in the art. A radiation-curable monofunctional monomer has one functional group, which takes part in the polymerisation reaction on curing. The polymerisable groups can be any group that are capable of polymerising upon exposure to radiation and are preferably selected from a (meth)acrylate group and a vinyl ether group.

The substituents of the monofunctional monomer are not limited other than by the constraints imposed by the use in an inkjet ink, such as viscosity, stability, toxicity etc. The substituents are typically alkyl, cycloalkyl, aryl and combinations thereof, any of which may be interrupted by heteroatoms. Non-limiting examples of substituents commonly used in the art include C₁₋₁₈ alkyl, C₃₋₁₈ cycloalkyl, C₆₋₁₀ aryl and combinations thereof, such as C₆₋₁₀ aryl- or C₃₋₁₈ cycloalkyl-substituted C₁₋₁₈ alkyl, any of which may be interrupted by 1-10 heteroatoms, such as oxygen or nitrogen, with nitrogen further substituted by any of the above described substituents. The substituents may together also form a cyclic structure.

In a preferred embodiment, the inkjet ink comprises a monofunctional monomer present in 10-40% by weight, more preferably 15-35% by weight, most preferably 20-30% by weight, based on the total weight of the ink.

In a preferred embodiment, the inkjet ink comprises a monofunctional (meth)acrylate monomer, which are well known in the art and are preferably the esters of acrylic acid. A detailed description is therefore not required. Mixtures of (meth)acrylates may also be used.

The substituents of the monofunctional (meth)acrylate monomer are not limited other than by the constraints imposed by the use in an inkjet ink, such as viscosity, stability, toxicity etc.

The monofunctional (meth)acrylate monomer may be a cyclic monofunctional (meth)acrylate monomer and/or an acyclic-hydrocarbon monofunctional (meth)acrylate monomer.

In a preferred embodiment, the monofunctional (meth)acrylate monomer comprises a cyclic monofunctional (meth)acrylate monomer.

The substituents of the cyclic monofunctional (meth)acrylate monomer are typically cycloalkyl, aryl and combinations thereof, any of which may be interrupted by heteroatoms and/or substituted by alkyl. Non-limiting examples of substituents commonly used in the art include C₃₋₁₈ cycloalkyl, C₆₋₁₀ aryl and combinations thereof, any of which may substituted with alkyl (such as C₁₋₁₈ alkyl) and/or any of which may be interrupted by 1-10 heteroatoms, such as oxygen or nitrogen, with nitrogen further substituted by any of the above described substituents. The substituents may together also form a cyclic structure.

The cyclic monofunctional (meth)acrylate monomer may be selected from isobornyl acrylate (IBOA), phenoxyethyl acrylate (PEA), cyclic TMP formal acrylate (CTFA), tetrahydrofurfuryl acrylate (THFA), (2-methyl-2-ethyl-1,3-dioxolane-4-yl)methyl acrylate (MEDA/Medol-10), 4-tert-butylcyclohexyl acrylate (TBCHA), 3,3,5-trimethylcyclohexyl acrylate (TMCHA) and mixtures thereof.

For food packaging applications where quality and safety of the materials is a concern, the cyclic monofunctional (meth)acrylate monomer may be selected from isobornyl acrylate (IBOA), cyclic TMP formal acrylate (CTFA), tetrahydrofurfuryl acrylate (THFA), (2-methyl-2-ethyl-1,3-dioxolane-4-yl)methyl acrylate (MEDA/Medol-10), 4-tert-butylcyclohexyl acrylate (TBCHA), 3,3,5-trimethylcyclohexyl acrylate (TMCHA) and mixtures thereof.

In a preferred embodiment, the monofunctional (meth)acrylate monomer comprises an acyclic-hydrocarbon monofunctional (meth)acrylate monomer.

The substituents of the acyclic-hydrocarbon monofunctional (meth)acrylate monomer are typically alkyl, which may be interrupted by heteroatoms. A non-limiting example of a substituent commonly used in the art is C₁₋₁₈ alkyl, which may be interrupted by 1-10 heteroatoms, such as oxygen or nitrogen, with nitrogen further substituted.

The acyclic-hydrocarbon monofunctional (meth)acrylate monomer contains a linear or branched C₆-C₂₀ group. It may be selected from octadecyl acrylate (ODA), 2-(2-ethoxyethoxy)ethyl acrylate, tridecyl acrylate (TDA), isodecyl acrylate (IDA), lauryl acrylate and mixtures thereof. In a preferred embodiment, the acyclic-hydrocarbon monofunctional (meth)acrylate monomer contains a linear C₆-C₂₀ group.

For food packaging applications, the acyclic-hydrocarbon monofunctional (meth)acrylate monomer may be selected from octadecyl acrylate (ODA), 2-(2-ethoxyethoxy)ethyl acrylate, tridecyl acrylate (TDA), lauryl acrylate and mixtures thereof.

In a preferred embodiment, the monofunctional (meth)acrylate monomer is selected from isobornyl acrylate (IBOA), phenoxyethyl acrylate (PEA), cyclic TMP formal acrylate (CTFA), tetrahydrofurfuryl acrylate (THFA), (2-methyl-2-ethyl-1,3-dioxolane-4-yl)methyl acrylate (MEDA/Medol-10), 4-tert-butylcyclohexyl acrylate (TBCHA), 3,3,5-trimethylcyclohexyl acrylate (TMCHA), octadecyl acrylate (ODA), 2-(2-ethoxyethoxy)ethyl acrylate, tridecyl acrylate (TDA), isodecyl acrylate (IDA), lauryl acrylate and mixtures thereof.

Lauryl acrylate is particularly preferred. Lauryl acrylate is preferred because it has a long straight chain that introduces flexibility into the cured ink film. However, because of its monofunctional nature, it is not crosslinked in the cured ink film and as such is prone to offset migration. As discussed below, the ebeam sterilisation step of the method of some of the embodiments reduces the amount of unreacted and migratable lauryl acrylate for food packaging applications.

For food packaging applications, the monofunctional (meth)acrylate monomer is preferably selected from isobornyl acrylate (IBOA), cyclic TMP formal acrylate (CTFA), tetrahydrofurfuryl acrylate (THFA), (2-methyl-2-ethyl-1,3-dioxolane-4-yl)methyl acrylate (MEDA/Medol-10), 4-tert-butylcyclohexyl acrylate (TBCHA), 3,3,5-trimethylcyclohexyl acrylate (TMCHA), octadecyl acrylate (ODA), 2-(2-ethoxyethoxy)ethyl acrylate, tridecyl acrylate (TDA), lauryl acrylate and mixtures thereof.

Preferably, the monofunctional (meth)acrylate monomer comprises lauryl acrylate. Preferably, lauryl acrylate is the sole monofunctional (meth)acrylate monomer present in the ink and more preferably, lauryl acrylate is the sole monofunctional monomer present in the ink.

In a preferred embodiment, the inkjet ink comprises a monofunctional (meth)acrylate monomer present in 10-40% by weight, more preferably 15-35% by weight, most preferably 20-30% by weight, based on the total weight of the ink.

Tetrahydrofurfuryl acrylate (THFA) is often used to provide good adhesion to variety of substrates, as well as producing a flexible film which is less liable to cracking and delamination. A further advantage of THFA is that it can solubilise chlorinated polyolefins, which in turn provides good adhesion to polyolefin substrates. However, THFA is a hazardous monomer and bears the GHS hazard statement H314 (Causes severe skin burns and eye damage). There is also growing evidence that it may damage fertility or the unborn child. Thus, there is an urgent need in the art to move away from THFA.

The ink will still function in the presence of tetrahydrofurfuryl acrylate (THFA), in terms of its printing and curing properties. However, to avoid the hazardous nature of THFA, the ink preferably contains less than 2% by weight, more preferably less than 1% by weight and most preferably is substantially free of THFA, where the amounts are based on the total weight of the ink.

By substantially free is meant that only small amounts will be present, for example as impurities in the radiation-curable materials present or as a component in a commercially available pigment dispersion. In other words, no THFA is intentionally added to the ink. However, minor amounts of THFA, which may be present as impurities in commercially available inkjet ink components, are tolerated. For example, the ink may comprise less than 0.5% by weight of THFA, more preferably less than 0.1% by weight of THFA, most preferably less than 0.05% by weight of THFA, based on the total weight of the ink. In a preferred embodiment, the inkjet ink is free of THFA.

For food packaging applications, the Swiss Ordinance on Materials and Articles in Contact with Food (SR 817.023.21) sets out provisions for inks. Annex 10 lists permitted substances for the production of food packaging inks. Substances not listed should not be used for food packaging inks. Caution should still be used for some substances on the Swiss Ordinance list and there is some concern about the quality and safety of the monofunctional (meth)acrylate monomers isodecyl acrylate (IDA), octyl acrylate, phenoxyethyl acrylate (PEA) and 2-ethylhexyl acrylate (2-EHA).

The ink preferably contains less than 2% by weight, more preferably less than 1% by weight and most preferably is substantially free of each of IDA, octyl acrylate, PEA and 2-EHA, where the amounts are based on the total weight of the ink. More preferably, the ink contains less than 5% by weight, more preferably less than 2% by weight, more preferably less than 1% by weight and most preferably is substantially free of IDA, octyl acrylate, PEA and 2-EHA in combination, where the amounts are based on the total weight of the ink.

By substantially free is meant that only small amounts will be present, for example as impurities in the radiation-curable materials present or as a component in a commercially available pigment dispersion. In other words, no IDA, octyl acrylate, PEA and 2-EHA is intentionally added to the ink. However, minor amounts of IDA, octyl acrylate, PEA and 2-EHA, which may be present as impurities in commercially available inkjet ink components, are tolerated. For example, the ink may comprise less than 0.5% by weight of each of IDA, octyl acrylate, PEA and 2-EHA, more preferably less than 0.1% by weight of each of IDA, octyl acrylate, PEA and 2-EHA, most preferably less than 0.05% by weight of each of IDA, octyl acrylate, PEA and 2-EHA, based on the total weight of the ink. Preferably, the ink may comprise less than 0.5% by weight of IDA, octyl acrylate, PEA and 2-EHA in combination, more preferably less than 0.1% by weight of IDA, octyl acrylate, PEA and 2-EHA in combination, most preferably less than 0.05% by weight of IDA, octyl acrylate, PEA and 2-EHA in combination, based on the total weight of the ink. In a preferred embodiment, the inkjet ink is free of IDA, octyl acrylate, PEA and 2-EHA.

Preferably, the monofunctional (meth)acrylate monomer is the sole monofunctional monomer present in the ink.

In a preferred embodiment, the radiation-curable material comprises a di- and/or multifunctional radiation-curable monomer and a monofunctional monomer. Preferably, the radiation-curable material consists of a di- and/or multifunctional radiation-curable monomer and a monofunctional monomer.

In a more preferred embodiment, the radiation-curable material comprises a difunctional monomer and a monofunctional monomer. Preferably, the radiation-curable material consists of a difunctional monomer and a monofunctional monomer.

In a most preferred embodiment, the radiation-curable material comprises a difunctional monomer and a monofunctional (meth)acrylate monomer. Preferably, the radiation-curable material consists of a difunctional monomer and a monofunctional (meth)acrylate monomer.

A particularly preferred monomer combination for some embodiments is 3-MPDDA, DVE-3 and lauryl acrylate.

The ink may further include at least one N-vinyl amide monomer, N-(meth)acryloyl amine monomer and/or N-vinyl carbamate monomer.

N-Vinyl amide monomers are well-known monomers in the art. N-Vinyl amide monomers have a vinyl group attached to the nitrogen atom of an amide which may be further substituted in an analogous manner to the (meth)acrylate monomers. Preferred examples are N-vinyl caprolactam (NVC), N-vinyl pyrrolidone (NVP), N-vinyl piperidone, N-vinyl formamide and N-vinyl acetamide.

Similarly, N-acryloyl amine monomers are also well-known in the art. N-Acryloyl amine monomers also have a vinyl group attached to an amide but via the carbonyl carbon atom and again may be further substituted in an analogous manner to the (meth)acrylate monomers. A preferred example is N-acryloylmorpholine (ACMO).

N-Vinyl carbamate monomers are defined by the following functionality:

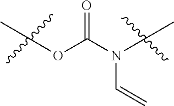 [SMILES: *OC(=O)N(*)C=C]

The synthesis of N-vinyl carbamate monomers is known in the art. For example, vinyl isocyanate, formed by the Curtius rearrangement of acryloyl azide, can be reacted with an alcohol to form N-vinyl carbamates (Phosgenations—A Handbook by L. Cotarca and H. Eckert, John Wiley & Sons, 2003, 4.3.2.8, pages 212-213).

If present, in a preferred embodiment, the N-vinyl carbamate monomer is an N-vinyl oxazolidinone. N-Vinyl oxazolidinones have the following structure:

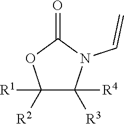

in which R¹ to R⁴ are not limited other than by the constraints imposed by the use in an ink-jet ink, such as viscosity, stability, toxicity etc. The substituents are typically hydrogen, alkyl, cycloalkyl, aryl and combinations thereof, any of which may be interrupted by heteroatoms. Non-limiting examples of substituents commonly used in the art include C₁₋₁₈ alkyl, C₃₋₁₈ cycloalkyl, C₆₋₁₀ aryl and combinations thereof, such as C₆₋₁₀ aryl- or C₃₋₁₈ cycloalkyl-substituted C₁₋₁₈ alkyl, any of which may be interrupted by 1-10 heteroatoms, such as oxygen or nitrogen, with nitrogen further substituted by any of the above described substituents. Preferably R¹ to R⁴ are independently selected from hydrogen or C₁₋₁₀ alkyl. Further details may be found in WO 2015/022228 and U.S. Pat. No. 4,831,153.

If present, most preferably, the N-vinyl carbamate monomer is N-vinyl-5-methyl-2-oxazolidinone (known as NVMO or VMOX). It is available from BASF and has the following structure:

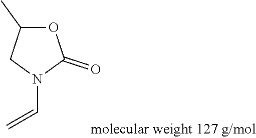

NVMO has the IUPAC name 5-methyl-3-vinyl-1,3-oxazolidin-2-one and CAS number 3395-98-0. NVMO includes the racemate and both enantiomers. In one embodiment, the N-vinyl carbamate monomer is a racemate of NVMO. In another embodiment, the N-vinyl carbamate monomer is (R)-5-methyl-3-vinyl-1,3-oxazolidin-2-one. Alternatively, the N-vinyl carbamate monomer is (S)-5-methyl-3-vinyl-1,3-oxazolidin-2-one.

If present, the inkjet ink preferably comprises at least one of NVC, ACMO and/or NVMO. N-Vinyl amide monomers are particularly preferred, and most preferably NVC.

The inkjet ink may also comprise one or more N-vinyl monomers other than an N-vinyl amide monomer, N-(meth)acryloyl amine monomer and/or N-vinyl carbamate monomer. Examples include N-vinyl carbazole, N-vinyl indole and N-vinyl imidazole.

In a preferred embodiment, the inkjet ink of may further comprise a radiation-curable (i.e. polymerisable) oligomer, such as a (meth)acrylate oligomer. Any radiation-curable oligomer that is compatible with the other ink components is suitable for use in the ink. Preferably, the inkjet ink comprises a (meth)acrylate oligomer.

The term “curable oligomer” has its standard meaning in the art, namely that the component is partially reacted to form a pre-polymer having a plurality of repeating monomer units, which is capable of further polymerisation. The oligomer preferably has a molecular weight of at least 600. The molecular weight is preferably 4,000 or less. Molecular weights (number average) can be calculated if the structure of the oligomer is known or molecular weights can be measured using gel permeation chromatography using polystyrene standards.

The oligomers may possess different degrees of functionality, and a mixture including combinations of mono, di, tri and higher functionality oligomers may be used. The degree of functionality of the oligomer determines the degree of crosslinking and hence the properties of the cured ink. The oligomer is preferably multifunctional meaning that it contains on average more than one reactive functional group per molecule. The average degree of functionality is preferably from 2 to 6.

Oligomers are typically added to inkjet inks to increase the viscosity of the inkjet ink or to provide film-forming properties such as hardness or cure speed. They therefore preferably have a viscosity of 150 mPas or above at 25° C. Preferred oligomers for inclusion in the ink of some embodiments have a viscosity of 0.5 to 10 Pas at 50° C. Oligomer viscosities can be measured using an ARG2 rheometer manufactured by T.A. Instruments, which uses a 40 mm oblique/2° steel cone at 60° C. with a shear rate of 25 s⁻¹.

Radiation-curable oligomers comprise a backbone, for example a polyester, urethane, epoxy or polyether backbone, and one or more radiation-curable groups.

The polymerisable group can be any group that is capable of polymerising upon exposure to radiation. Preferably the oligomers are (meth)acrylate oligomers. The oligomer may include amine functionality, as the amine acts as an activator without the drawback of migration associated with low-molecular weight amines. In a preferred embodiment, the radiation-curable oligomer is amine modified. In a particularly preferred embodiment, the radiation-curable oligomer is an amine-modified (meth)acrylate oligomer.

Particularly preferred radiation-curable oligomers are di-, tri-, tetra-, penta- or hexa-functional acrylates.

More preferably, the radiation-curable oligomer is an amine-modified acrylate oligomer. A suitable amine-modified polyester acrylate oligomer is commercially available as UVP6600. A suitable amine-modified polyether acrylate oligomer is commercially available as CN3715LM.

Other suitable examples of radiation-curable oligomers include epoxy based materials such as bisphenol A epoxy acrylates and epoxy novolac acrylates, which have fast cure speeds and provide cured films with good solvent resistance. However, for food packaging applications where quality and safety of the materials is a concern, the ink is preferably substantially free of bisphenol A based materials such as bisphenol A epoxy acrylates. Therefore, the ink is preferably substantially free of bisphenol A epoxy acrylates.

By substantially free is meant that only small amounts will be present, for example as impurities in the radiation-curable materials present or as a component in a commercially available pigment dispersion. In other words, no bisphenol A epoxy acrylates is intentionally added to the ink. However, minor amounts of bisphenol A epoxy acrylates which may be present as impurities in commercially available inkjet ink components, are tolerated. For example, the ink may comprise less than 0.5% by weight of bisphenol A epoxy acrylates, more preferably less than 0.1% by weight of bisphenol A epoxy acrylates, most preferably less than 0.05% by weight of bisphenol A epoxy acrylates, based on the total weight of the ink. In a preferred embodiment, the inkjet ink is free of bisphenol A epoxy acrylates.

The amount of radiation-curable oligomer, when present, is preferably 0.1-10% by weight, based on the total weight of the ink.

The ink may also contain a resin. The resin preferably has a weight-average molecular weight (Mw) of 10-50 KDa, and most preferably 15-35 KDa. The Mw may be measured by known techniques in the art, such as gel permeation chromatography (GPC), using a polystyrene standard. The resin is preferably solid at 25° C. It is preferably soluble in the liquid medium of the ink (the radiation-curable diluent and, when present, additionally the solvent).

The resin is a passive (i.e. inert) resin, in the sense that it is not radiation curable and hence does not undergo cross-linking under the curing conditions to which the ink is subjected.

The resin may improve adhesion of the ink to the substrate. It is preferably soluble in the ink. The resin, when present, is preferably present at 0.1-5% by weight, based on the total weight of the ink.

In a preferred embodiment, the inkjet ink also includes a colouring agent, which may be either dissolved or dispersed in the liquid medium of the ink. The colouring agent can be any of a wide range of suitable colouring agents that would be known to the person skilled in the art.

Preferably, the colouring agent is a dispersed pigment, of the types known in the art and commercially available such as under the trade-names Paliotol (available from BASF plc), Cinquasia, Irgalite (both available from Ciba Speciality Chemicals) and Hostaperm (available from Clariant UK). The pigment may be of any desired colour such as, for example, Pigment Yellow 13, Pigment Yellow 83, Pigment Red 9, Pigment Red 184, Pigment Blue 15:3, Pigment Green 7, Pigment Violet 19, Pigment Black 7.

Especially useful are black and the colours required for trichromatic process printing. Mixtures of pigments may be used.

In one aspect the following pigments are preferred. Cyan: phthalocyanine pigments such as Phthalocyanine blue 15.4. Yellow: azo pigments such as Pigment yellow 120, Pigment yellow 151 and Pigment yellow 155. Magenta: quinacridone pigments, such as Pigment violet 19 or mixed crystal quinacridones such as Cromophtal Jet magenta 2BC and Cinquasia RT-3550. Black: carbon black pigments such as Pigment black 7.

Pigment particles dispersed in the ink should be sufficiently small to allow the ink to pass through an inkjet nozzle, typically having a particle size less than 8 μm, preferably less than 5 μm, more preferably less than 1 μm and particularly preferably less than 0.5 μm.

The colorant is preferably present in an amount of 0.2-20% by weight, preferably 0.5-10% by weight, based on the total weight of the ink. A higher concentration of pigment may be required for white inks, for example up to and including 30% by weight, or 25% by weight, based on the total weight of the ink.

In a preferred embodiment the radiation-curable material polymerises by free-radical polymerisation.

If the ink is cured by exposure to a source of actinic radiation, one or more photoinitiators will be required.

In a preferred embodiment, the ink used in the method further comprises a photoinitiator. Preferred are photoinitiators which produce free radicals on irradiation (free radical photoinitiators) such as, for example, benzophenone, 1-hydroxycyclohexyl phenyl ketone, 2-benzyl-2-dimethylamino-(4-morpholinophenyl)butan-1-one, benzil dimethylketal, phenylbis(2,4,6-trimethylbenzoyl) phosphine oxide or mixtures thereof. Such photoinitiators are known and commercially available such as, for example, under the trade names Omnirad (from IGM) and Esacure (from Lambeti).

Mixtures of free radical photoinitiators can be used and if present, the ink preferably comprises a plurality of free radical photoinitiators. The total number of free radical photoinitiators present is preferably from one to five, and more preferably, two or more free radical photoinitiators are present in the ink.

For food packaging applications, there is some concern about the negative odour/taint, migration potential and/or safety of 2-hydroxy 2-methyl propiophenone, 2-(dimethylamino)ethyl benzoate, benzophenone, 2-methyl benzophenone, 4-methyl benzophenone, 2,4,6-trimethyl benzophenone, 1-hydroxycyclohexyl phenyl ketone, 2,2-dimethoxy 2-phenyl acetophenone, 2-methyl 4′-(methylthio) 2-morpholino-propiophenone, 2-isopropyl 9H-thioxanthen-9-one (2-ITX), 4-isopropyl 9H-thioxanthen-9-one (4-ITX), 2,4-diethyl 9H-thioxanthen-9-one and diphenyl (2,4,6-trimethyl benzoyl) phosphine oxide.

Therefore, in a preferred embodiment, the ink preferably contains less than 5% by weight, more preferably less than 2% by weight, more preferably less than 1% by weight and most preferably is substantially free of each of 2-hydroxy 2-methyl propiophenone, 2-(dimethylamino)ethyl benzoate, benzophenone, 2-methyl benzophenone, 4-methyl benzophenone, 2,4,6-trimethyl benzophenone, 1-hydroxycyclohexyl phenyl ketone, 2,2-dimethoxy 2-phenyl acetophenone, 2-methyl 4′-(methylthio) 2-morpholino-propiophenone, 2-isopropyl 9H-thioxanthen-9-one (2-ITX), 4-isopropyl 9H-thioxanthen-9-one (4-ITX), 2,4-diethyl 9H-thioxanthen-9-one and diphenyl (2,4,6-trimethyl benzoyl) phosphine oxide, where the amounts are based on the total weight of the ink.

By substantially free is meant that only small amounts will be present, for example as impurities in the radiation-curable materials present or as a component in a commercially available pigment dispersion. In other words, no 2-hydroxy 2-methyl propiophenone, 2-(dimethylamino)ethyl benzoate, benzophenone, 2-methyl benzophenone, 4-methyl benzophenone, 2,4,6-trimethyl benzophenone, 1-hydroxycyclohexyl phenyl ketone, 2,2-dimethoxy 2-phenyl acetophenone, 2-methyl 4′-(methylthio) 2-morpholino-propiophenone, 2-isopropyl 9H-thioxanthen-9-one (2-ITX), 4-isopropyl 9H-thioxanthen-9-one (4-ITX), 2,4-diethyl 9H-thioxanthen-9-one and diphenyl (2,4,6-trimethyl benzoyl) phosphine oxide is intentionally added to the ink. However, minor amounts of each of 2-hydroxy 2-methyl propiophenone, 2-(dimethylamino)ethyl benzoate, benzophenone, 2-methyl benzophenone, 4-methyl benzophenone, 2,4,6-trimethyl benzophenone, 1-hydroxycyclohexyl phenyl ketone, 2,2-dimethoxy 2-phenyl acetophenone, 2-methyl 4′-(methylthio) 2-morpholino-propiophenone, 2-isopropyl 9H-thioxanthen-9-one (2-ITX), 4-isopropyl 9H-thioxanthen-9-one (4-ITX), 2,4-diethyl 9H-thioxanthen-9-one and diphenyl (2,4,6-trimethyl benzoyl) phosphine oxide, which may be present as impurities in commercially available inkjet ink components, are tolerated. For example, the ink may comprise less than 0.5% by weight, more preferably less than 0.1% by weight, most preferably less than 0.05% by weight of each of 2-hydroxy 2-methyl propiophenone, 2-(dimethylamino)ethyl benzoate, benzophenone, 2-methyl benzophenone, 4-methyl benzophenone, 2,4,6-trimethyl benzophenone, 1-hydroxycyclohexyl phenyl ketone, 2,2-dimethoxy 2-phenyl acetophenone, 2-methyl 4′-(methylthio) 2-morpholino-propiophenone, 2-isopropyl 9H-thioxanthen-9-one (2-ITX), 4-isopropyl 9H-thioxanthen-9-one (4-ITX), 2,4-diethyl 9H-thioxanthen-9-one and diphenyl (2,4,6-trimethyl benzoyl) phosphine oxide, based on the total weight of the ink. In a preferred embodiment, the inkjet ink is free of each of 2-hydroxy 2-methyl propiophenone, 2-(dimethylamino)ethyl benzoate, benzophenone, 2-methyl benzophenone, 4-methyl benzophenone, 2,4,6-trimethyl benzophenone, 1-hydroxycyclohexyl phenyl ketone, 2,2-dimethoxy 2-phenyl acetophenone, 2-methyl 4′-(methylthio) 2-morpholino-propiophenone, 2-isopropyl 9H-thioxanthen-9-one (2-ITX), 4-isopropyl 9H-thioxanthen-9-one (4-ITX), 2,4-diethyl 9H-thioxanthen-9-one and diphenyl (2,4,6-trimethyl benzoyl) phosphine oxide.

More preferably, the ink contains less than 5% by weight, more preferably less than 2% by weight, more preferably less than 1% by weight and most preferably is substantially free of 2-hydroxy 2-methyl propiophenone, 2-(dimethylamino)ethyl benzoate, benzophenone, 2-methyl benzophenone, 4-methyl benzophenone, 2,4,6-trimethyl benzophenone, 1-hydroxycyclohexyl phenyl ketone, 2,2-dimethoxy 2-phenyl acetophenone, 2-methyl 4′-(methylthio) 2-morpholino-propiophenone, 2-isopropyl 9H-thioxanthen-9-one (2-ITX), 4-isopropyl 9H-thioxanthen-9-one (4-ITX), 2,4-diethyl 9H-thioxanthen-9-one and diphenyl (2,4,6-trimethyl benzoyl) phosphine oxide in combination, where the amounts are based on the total weight of the ink.

By substantially free is meant that only small amounts will be present, for example as impurities in the radiation-curable materials present or as a component in a commercially available pigmentdispersion. In other words, no 2-hydroxy 2-methyl propiophenone, 2-(dimethylamino)ethyl benzoate, benzophenone, 2-methyl benzophenone, 4-methyl benzophenone, 2,4,6-trimethyl benzophenone, 1-hydroxycyclohexyl phenyl ketone, 2,2-dimethoxy 2-phenyl acetophenone, 2-methyl 4′-(methylthio) 2-morpholino-propiophenone, 2-isopropyl 9H-thioxanthen-9-one (2-ITX), 4-isopropyl 9H-thioxanthen-9-one (4-ITX), 2,4-diethyl 9H-thioxanthen-9-one and diphenyl (2,4,6-trimethyl benzoyl) phosphine oxide is intentionally added to the ink. However, minor amounts of 2-hydroxy 2-methyl propiophenone, 2-(dimethylamino)ethyl benzoate, benzophenone, 2-methyl benzophenone, 4-methyl benzophenone, 2,4,6-trimethyl benzophenone, 1-hydroxycyclohexyl phenyl ketone, 2,2-dimethoxy 2-phenyl acetophenone, 2-methyl 4′-(methylthio) 2-morpholino-propiophenone, 2-isopropyl 9H-thioxanthen-9-one (2-ITX), 4-isopropyl 9H-thioxanthen-9-one (4-ITX), 2,4-diethyl 9H-thioxanthen-9-one and diphenyl (2,4,6-trimethyl benzoyl) phosphine oxide in combination, which may be present as impurities in commercially available inkjet ink components, are tolerated. For example, the ink may comprise less than 0.5% by weight, more preferably less than 0.1% by weight, most preferably less than 0.05% by weight of 2-hydroxy 2-methyl propiophenone, 2-(dimethylamino)ethyl benzoate, benzophenone, 2-methyl benzophenone, 4-methyl benzophenone, 2,4,6-trimethyl benzophenone, 1-hydroxycyclohexyl phenyl ketone, 2,2-dimethoxy 2-phenyl acetophenone, 2-methyl 4′-(methylthio) 2-morpholino-propiophenone, 2-isopropyl 9H-thioxanthen-9-one (2-ITX), 4-isopropyl 9H-thioxanthen-9-one (4-ITX), 2,4-diethyl 9H-thioxanthen-9-one and diphenyl (2,4,6-trimethyl benzoyl) phosphine oxide in combination, based on the total weight of the ink. In a preferred embodiment, the inkjet ink is free of 2-hydroxy 2-methyl propiophenone, 2-(dimethylamino)ethyl benzoate, benzophenone, 2-methyl benzophenone, 4-methyl benzophenone, 2,4,6-trimethyl benzophenone, 1-hydroxycyclohexyl phenyl ketone, 2,2-dimethoxy 2-phenyl acetophenone, 2-methyl 4′-(methylthio) 2-morpholino-propiophenone, 2-isopropyl 9H-thioxanthen-9-one (2-ITX), 4-isopropyl 9H-thioxanthen-9-one (4-ITX), 2,4-diethyl 9H-thioxanthen-9-one and diphenyl (2,4,6-trimethyl benzoyl) phosphine oxide.

Polymeric photoinitiators are preferred. Examples include Omnipol TP®, Omnipol 910® and Speedcure 7010®.

Omnipol TP® is commercially available from IGM. It is a polymeric phosphine oxide photoinitiator, and is known by the chemical name polymeric ethyl (2,4,6-trimethylbenzoyl)-phenyl phosphinate or polymeric TPO-L. It has the following structure:

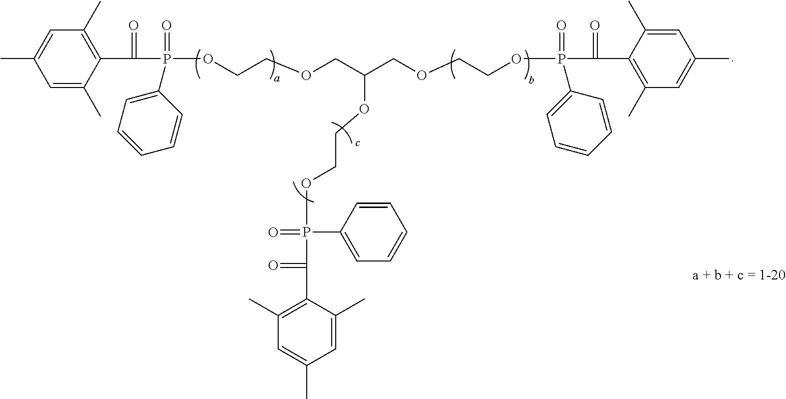

The total value of a, b and c of the chemical formula for polymeric TPO-L is equal to 1-20.

Omnipol 910® is also commercially available from IGM. It is a piparazino-based aminoalkylphenone having the following structure:

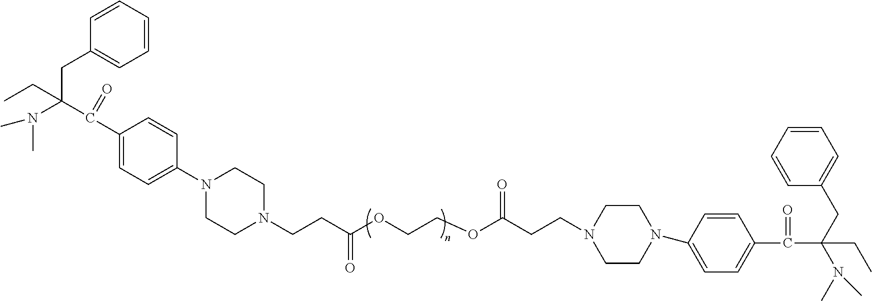

The value of n of the chemical formula for Omnipol 910® is equal to 1-10.

Speedcure 7010L® is a particularly preferred photoinitiator for inclusion in the ink used in the method of some embodiments. Speedcure 7010L® is commercially available from Lambson®. Speedcure 7010L® is a liquid at 20° C. and is a solution of 1,3-di({α-[1-chloro-9-oxo-9H-thioxanthen-4-yl)oxy]acetylpoly[oxy(1-methylethylene)]}oxy)-2,2-bis({α-[1-chloro-9-oxo-9H-thioxanthen-4-yl)oxy]acetylpoly[oxy(1-methylethylene)]}oxymethyl) propane in trimethylolpropane ethoxylate triacrylate. 1,3-Di({α-[1-chloro-9-oxo-9H-thioxanthen-4-yl)oxy]acetylpoly[oxy(1-methylethylene)]}oxy)-2,2-bis({α-[1-chloro-9-oxo-9H-thioxanthen-4-yl)oxy]acetylpoly[oxy(1-methylethylene)]}oxymethyl) propane is known as polymeric ITX and has the following structure:

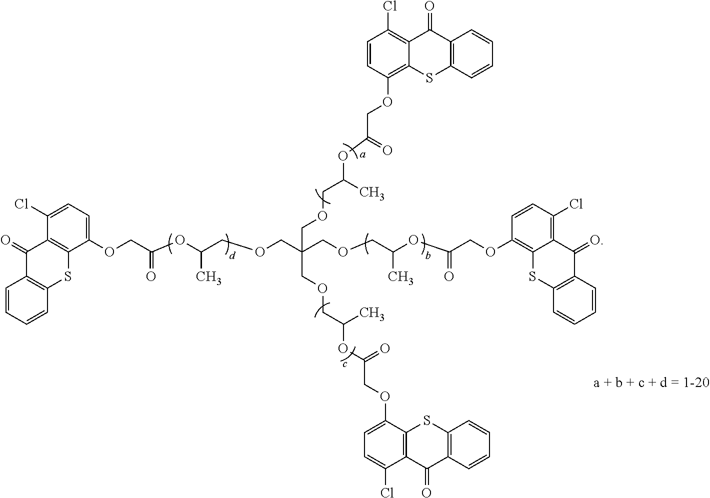

The total value of a, b, c and d of the chemical formula for polymeric ITX is equal to 1-20. In a preferred embodiment, the value of a+b+c+d of the chemical formula for polymeric ITX is equal to 1-15.

Preferably, the photoinitiator is present from 1 to 20% by weight, preferably from 5 to 15% by weight, of the ink.

However, the presence of a photoinitiator is optional as it is not necessary to include a photoinitiator in the inkjet ink in order to achieve a thorough cure of the ink. This is because the ink can cure without the presence of a photoinitiator by curing with a low-energy electron beam.

An inkjet ink that is cured with a low-energy electron beam may still contain 5% by weight or less of a photoinitiator, based on the total weight of the ink, if the ink is first pinned with actinic radiation.

By pinning is meant arresting the flow of the ink by treating the ink droplets quickly after they have impacted onto the substrate surface. Pinning provides a partial cure of the ink and thereby maximises image quality by controlling bleed and feathering between image areas. Pinning does not achieve full cure of the ink. By curing is meant fully curing the ink. Pinning leads to a marked increase in viscosity, whereas curing converts the inkjet ink from a liquid ink to a solid film. The dose of radiation used for pinning is generally lower than the dose required to cure the radiation-curable material fully.

In an alternative preferred embodiment, the photoinitiator is present in an amount of 10% by weight or less, preferably 5% by weight or less, more preferably 4% or less, more preferably 3% or less, more preferably 2% or less and more preferably 1% or less, based on the total weight of the ink. Most preferably, the inkjet ink is substantially free of photoinitiator.

By substantially free is meant that only small amounts will be present, for example as impurities in the radiation-curable materials present or as a component in a commercially available pigment dispersion. In other words, no photoinitiator is intentionally added to the ink. However, minor amounts of a photoinitiator, which may be present as impurities in commercially available inkjet ink components, are tolerated. For example, the ink may comprise less than 0.5% by weight, more preferably less than 0.1% by weight and most preferably less than 0.05% by weight of a photoinitiator, based on the total weight of the ink. In a preferred embodiment, the inkjet ink is free of a photoinitiator.

An inkjet ink that is substantially free of photoinitiator is advantageous for various applications as there will be no unreacted photoinitiator or unreacted photoinitiator fragments present in the cured inkjet ink film. Photoinitiators create free radicals when exposed to radiation. These radicals react with reactive components of the ink (such as reactive monomers and oligomers). However, some photoinitiator and photoinitiator fragments will remain unreacted in the cured ink film and this is problematic for certain applications as such unreacted components can migrate into the substrate. In the ink of some embodiments, photoinitiator is not necessary to achieve cure when curing the ink with low-energy electron beam.

The inkjet ink preferably dries primarily by curing, i.e. by the polymerisation of the monomers present, as discussed hereinabove, and hence is a curable ink. The ink does not, therefore, require the presence of water or a volatile organic solvent to effect drying of the ink. Preferably, the inkjet ink comprises less than 5% by weight of water and volatile organic solvent combined, preferably less than 3% by weight combined, more preferably, less than 2% by weight combined, more preferably less than 1% by weight combined and most preferably the inkjet ink is substantially free of water and volatile organic solvents, where the amounts are based on the total weight of the ink.

By substantially free is meant that only small amounts will be present, for example some water will typically be absorbed by the ink from the air and solvents may be present as impurities in the components of the inks, but such low levels are tolerated. In other words, no water or a volatile organic solvent is intentionally added to the ink. However, minor amounts of water or a volatile organic solvent, which may be present as impurities in commercially available inkjet ink components, are tolerated. For example, the ink may comprise less than 0.5% by weight of water or a volatile organic solvent, more preferably less than 0.1% by weight of water or a volatile organic solvent, most preferably less than 0.05% by weight of water or a volatile organic solvent, based on the total weight of the ink. In a preferred embodiment, the inkjet ink is free of water or a volatile organic solvent.

In a preferred embodiment, the inkjet ink comprises a surfactant. The surfactant controls the surface tension of the ink. Surfactants are well known in the art and a detailed description is not required. An example of a suitable surfactant is BYK307. Adjustment of the surface tension of the inks allows control of the surface wetting of the inks on various substrates, for example, plastic substrates. Too high a surface tension can lead to ink pooling and/or a mottled appearance in high coverage areas of the print. Too low a surface tension can lead to excessive ink bleed between different coloured inks. Surface tension is also critical to ensuring stable jetting (nozzle plate wetting and sustainability). The surface tension is preferably in the range of 18-40 mNm⁻¹, more preferably 20-35 mNm⁻¹ and most preferably 20-30 mNm⁻¹.

Other components of types known in the art may be present in the ink of some embodiments to improve the properties or performance. These components may be, for example, additional surfactants, defoamers, dispersants, synergists, stabilisers against deterioration by heat or light other than an aerobic stabiliser, reodorants, flow or slip aids, biocides and identifying tracers.

The inks of some embodiments may be prepared by known methods such as, for example, stirring with a high-speed water-cooled stirrer, or milling on a horizontal bead-mill.

The ink used in the method of some embodiments is applied by inkjet printing. The ink exhibits a desirable low viscosity, less than 100 mPas, preferably 50 mPas or less, most preferably 30 mPas or less and most preferably 20 mPas or less at 25° C. The ink most preferably has a viscosity of 8 to 20 mPas at 25° C. Viscosity may be measured using a digital Brookfield viscometer fitted with a thermostatically controlled cup and spindle arrangement, such as model DV1.

The method of some embodiments further comprises: (ii) inkjet printing the inkjet ink onto one or more substrates to produce one or more substrates having a printed surface and an unprinted surface.

Printing is performed by inkjet printing, e.g. on a single-pass inkjet printer, for example for printing (directly) onto a substrate, on a roll-to-roll printer or a flat-bed printer. As discussed above, inkjet printing is well known in the art and a detailed description is not required.

The ink is jetted from one or more reservoirs or printing heads through narrow nozzles on to one or more substrates to form a printed image.

Print heads account for a significant portion of the cost of an entry level printer and it is therefore desirable to keep the number of print heads (and therefore the number of inks in the ink set) low. Reducing the number of print heads can reduce print quality and productivity. It is therefore desirable to balance the number of print heads in order to minimise cost without compromising print quality and productivity.

Substrates include those for packaging applications and in particular, flexible packaging applications. Examples include substrates composed of polyvinyl chloride (PVC), polystyrene, polyester, polyethylene terephthalate (PET), polyethylene terephthalate glycol modified (PETG) and polyolefin (e.g. polyethylene, polypropylene or mixtures or copolymers thereof). Further substrates include all cellulosic materials such as paper and board, or their mixtures/blends with the aforementioned synthetic materials.

Particularly preferred substrates are a food packaging. Food packaging is typically formed of flexible and rigid plastics (e.g. food-grade polystyrene and PE/PP films), paper and board (e.g. corrugated board). Printing onto a food packaging substrate represents a particular challenge on account of the strict safety limitations on the properties of materials which come into contact with food, including indirect additives like packaging inks. For printed food packaging, it is necessary to control and quantify the migration and/or odour of the components of the printed image on the food packaging into the food products. Specific exclusions based on their odour and/or migration properties include volatile organic solvents and many monomers typically used in UV curing inks. Preferably, the monomers of the ink used in the method of some embodiments are suitable for food packaging applications.

When discussing the one or more substrates, it is the surface which is most important, since it is the surface which is wetted by the ink. Thus, at least the surface of the one or more substrates is composed of the above-discussed material.

In a preferred embodiment, the one or more substrates is a laminate carton material comprising the following layers, in order: an inner polyethylene layer; an aluminium layer; a board layer and an outer polyethylene layer. By inner is meant a surface of the substrate that would come into contact with food and by outer is meant a surface of the substrate that would come into contact with the inkjet ink used in the method of some embodiments. More preferably, the polyethylene layer is corona treated to a surface tension of more than 45 dynes/cm using a Vetaphone unit. This provides improved adhesion of the ink.

In order to produce a high quality printed image a small jetted drop size is desirable. Preferably the inkjet ink is jetted at drop sizes below 90 picolitres, preferably below 35 picolitres and most preferably below 10 picolitres.

To achieve compatibility with print heads that are capable of jetting drop sizes of 90 picolitres or less, a low viscosity ink is required. A viscosity of 30 mPas or less at 25° C. is preferred, for example, 8 to 12 mPas, 18 to 20 mPas, or 24 to 26 mPas. Ink viscosity may be measured using a Brookfield viscometer fitted with a thermostatically controlled cup and spindle arrangement, such as a DV1 low-viscosity viscometer running at 20 rpm at 25° C. with spindle 00.

The method of some embodiments further comprises: (iii) curing the printed surface of the one or more substrates by exposure to a source of actinic radiation and/or a first source of low-energy electron beam radiation.

It should be noted that the terms “dry” and “cure” are often used interchangeably in the art when referring to radiation-curable inkjet inks to mean the conversion of the inkjet ink from a liquid to solid by polymerisation and/or crosslinking of the radiation-curable material. Herein, however, by “drying” is meant the removal of the water by evaporation and by “curing” is meant the polymerisation and/or crosslinking of the radiation-curable material. Further details of the printing, drying and curing process are provided in WO 2011/021052.

The source of actinic radiation can be any source of actinic radiation that is suitable for curing radiation-curable inks but is preferably a UV source. Suitable UV sources are well known in the art and a detailed description is not required. These include mercury discharge lamps, fluorescent tubes, light emitting diodes (LEDs), flash lamps and combinations thereof. One or more mercury discharge lamps, fluorescent tubes, or flash lamps may be used as the radiation source.

Preferably, the source of actinic radiation is a mercury discharge lamp and/or LEDs. When LEDs are used, these are preferably provided as an array of multiple LEDs.

The most common UV light source used to cure inkjet inks is a mercury discharge lamp. These lamps operate by creating a plasma between two electrodes in a high pressure mercury gas contained in a quartz envelope. Although these lamps have some drawbacks in terms of their operational characteristics, no other UV light source has yet managed to challenge their position in terms of UV output performance.

LEDs are increasingly used to cure inkjet inks. UV light is emitted from a UV LED light source. UV LED light sources comprise one or more LEDs and are well known in the art. Thus, a detailed description is not required.

It will be understood that UV LED light sources emit radiation having a spread of wavelengths. The emission of UV LED light sources is identified by the wavelength which corresponds to the peak in the wavelength distribution. Compared to conventional mercury lamp UV sources, UV LED light sources emit UV radiation over a narrow range of wavelengths on the wavelength distribution. The width of the range of wavelengths on the wavelength distribution is called a wavelength band. LEDs therefore have a narrow wavelength output when compared to other sources of UV radiation. By a narrow wavelength band, it is meant that at least 90%, preferably at least 95%, of the radiation emitted from the UV LED light source has a wavelength within a wavelength band having a width of 50 nm or less, preferably, 30 nm or less, most preferably 15 nm or less.

In a preferred embodiment, at least 90%, preferably at least 95%, of the radiation emitted from the UV LED light source has a wavelength in a band having a width of 50 nm or less, preferably 30 nm or less, most preferably 15 nm or less.

LEDs have a longer lifetime and exhibit no change in the power/wavelength output over time. LEDs also have the advantage of switching on instantaneously with no thermal stabilisation time and their use results in minimal heating of the substrate.

In a preferred embodiment, the printed surface of the one or more substrates is cured by exposure to a source of actinic radiation. More preferably, the dose of actinic radiation is greater than 200 mJ/cm². This dose results in the formation of a solid film and does not merely pin the ink. More preferably, the dose of actinic radiation is at least 300 mJ/cm² and most preferably at least 500 mJ/cm². The upper limit is less relevant and will be limited only by the commercial factor that more powerful radiation sources increase cost. A typical upper limit would be 5 J/cm².

The first source of low-energy electron beam (ebeam) radiation can be any source of low-energy electron beam radiation that is suitable for curing radiation-curable inks. Suitable low-energy electron beam radiation sources include commercially available ebeam curing units, such as the EB Lab from ebeam Technologies with energy of 80-300 keV and capable of delivering a typical dose of 30-50 kGy at line speeds of up to 30 m/min. By “low-energy” for the ebeam, it is meant that it delivers an electron beam having a dose at the substrate of 100 kGy or less, preferably 70 kGy or less.

Ebeam curing is characterised by dose (energy per unit mass, measured in kilograys (kGy)) deposited in the substrate via electrons. Electron beam surface penetration depends upon the mass, density and thickness of the material being cured. Compared with UV penetration, electrons penetrate deeply through both lower and higher density materials. Unlike UV curing, photoinitiators are not required for ebeam curing to take place.

Ebeam curing is well-known in the art and therefore a detailed explanation of the curing method is not required. In order to cure the printed ink, the ink of some embodiments is exposed to the ebeam, which produces sufficient energy to instantaneously break chemical bonds and enable polymerisation or crosslinking.

There is no restriction on the ebeam dose that is used to cure the inkjet inks of some embodiments other than that the dose is sufficient to fully cure the ink. In a preferred embodiment, the dose provided by the first source of low-energy electron beam radiation is 10-100 kGy. More preferably, the dose is more than 10 kGy, more preferably more than 20 kGy, more preferably more than 30 kGy and most preferably more than 40 kGy. Preferably, the dose is less than 100 kGy, more preferably less than 90 kGy, more preferably less than 80 kGy and most preferably less than 70 kGy. Preferably, the dose is more than 30 kGy but less than 70 kGy, more preferably more than 30 kGy but less than 60 kGy and most preferably, more than 30 kGy but 50 kGy or less. Doses above 50 kGy may cause damage to the substrate, particularly the substrates used for food packaging applications, and so doses of 50 kGy or less are preferred.

The energy associated with these doses is 80-300 keV, more preferably 70-200 keV and most preferably 100 keV.

In a preferred embodiment, the printed surface of the one or more substrates is cured by exposure to a first source of low-energy electron beam radiation. Preferably, the printed surface of the substrate is cured in the presence of an oxygen-deficient atmosphere, more preferably a nitrogen atmosphere. Curing in the presence of an oxygen-deficient atmosphere is well-known in the art and therefore a detailed explanation is not required.

In one embodiment, the printed surface of the substrate is cured by exposure to a source of actinic radiation. In another embodiment, the printed surface of the substrate is cured by exposure to a first source of low-energy electron beam radiation. In a further embodiment, the printed surface of the substrate is cured by exposure to a source of actinic radiation and a first source of low-energy electron beam radiation. Preferably however, the printed surface of the substrate is cured by exposure to a source of actinic radiation.

The ink cures to form a relatively thin polymerised film. The ink of some embodiments typically produces a printed film having a thickness of 1 to 20 μm, preferably 1 to 10 μm, for example 2 to 5 μm. Film thicknesses can be measured using a confocal laser scanning microscope.

The method of some embodiments further comprises: (iv) storing the one or more substrates such that the printed surface of the one or more substrates is in contact with the unprinted surface of the one or more substrates.

By storing is meant that the one or more substrates is not used “in-line”. For example, for food packaging applications, an “in-line” process involves directly transferring the one or more substrates from a print/cure unit to a filling machine. By storing the one or more substrates, the printed surface of the one or more substrates comes into contact with the unprinted surface of the one or more substrates. Storing the one or more substrates allows the one or more substrates to be used later but because the printed surface of the one or more substrates comes into contact with the unprinted surface of the one or more substrates, offset migration can occur as described above.

In a preferred embodiment, the one or more substrates is one substrate stored as a roll. A typical roll has a diameter of 1150 mm, a width of 214 mm and a weight of 170 kg. The middle of such a roll therefore experiences significant pressure, and the substrate at and near the middle of the roll can suffer from significant offset migration.

The method of the some embodiments may be used in reel-to-reel printing. In a preferred embodiment, steps (ii) and (iii) of the method occur as the substrate is caused to move from a substrate reel to a receiving reel.

The method of some embodiments may also be used in a flat-bed inkjet printer in an automated or semi-automated process where the printed substrates are stacked one on top of another. In an alternative preferred embodiment, the one or more substrates is a plurality of substrates stored as a stack of printed substrates. The stack of printed substrates, especially near the bottom of the stack, can experience significant pressure and thus suffer from significant offset migration.

The process may be semi-automated in that the plurality of substrates are fed manually into the printer, or automated where the printer contains a substrate-storage facility having the plurality of substrates held therein.

In this embodiment, the method of some embodiments involves (ii) inkjet printing the inkjet ink onto a plurality of substrates to produce a plurality of substrates having a printed surface and an unprinted surface; (iii) curing the printed surface of the plurality of substrates by exposure to a source of actinic radiation and/or a first source of low-energy electron beam radiation; (iv) storing the plurality of substrates as a stack of printed substrates such that the printed surface of the plurality of substrates is in contact with the unprinted surface of the plurality of substrates; and (v) separating the printed and unprinted surfaces of the plurality of substrates and sterilising the plurality of substrates by exposure to a second source of low-energy electron beam radiation.

The method of some embodiments further comprises: (v) separating the printed and unprinted surfaces of the one or more substrates and sterilising the one or more substrates by exposure to a second source of low-energy electron beam radiation.

How the printed and unprinted surfaces of the one or more substrates are separated depends on how the one or more substrates is stored. For example, if the one or more substrates is one substrate stored as a roll, the substrate is unwound.

The one or more substrates is then sterilised by exposure to a second source of low-energy electron beam radiation. In aseptic packaging processes, the printed material is sterilised before filling with the foodstuff. The sterilisation can be undertaken using, for example, aqueous H₂O₂ or ebeam radiation. The inventors have discovered that, in some cases, if ebeam radiation is used for the sterilisation of substrates printed with radiation-curable inkjet inks, then the potential for contamination of the foodstuff by components of the printed ink film is greatly reduced. Without wishing to be bound by theory, it is believed that the ebeam radiation initiates polymerisation of any unreacted radiation-curable material that has transferred to the food packaging side (and so are capable of contaminating the foodstuff) owing to storage causing offset migration. Polymerisation produces high molecular weight species, which significantly reduces the hazard posed by the printed substrate and enables compliance with food standards to be achieved.

Ebeam sterilisation is particularly advantageous when radiation-curable material that is prone to offset migration such as DVE-3 and lauryl acrylate is present in the radiation-curable material of the inkjet ink.

There is no restriction on the ebeam dose that is used to sterilise the substrate other than that the dose is sufficient to sterilise the substrate. Suitable and preferred doses and energies for the second source of low-energy ebeam radiation are the same as those given above for the first source of low-energy ebeam radiation.

By first and second is meant that the sources of low-energy ebeam radiation are distinct. The first source of low-energy ebeam radiation cures the ink and the second source of low-energy ebeam radiation sterilises the one or more substrates.

Some embodiments also provide a printed substrate obtainable by any of the disclosed methods. Preferably, the substrate is a food packaging.

Some embodiments will now be described with reference to the following examples, which are not intended to be limiting.

### EXAMPLES

### Example 1

Inkjet inks were prepared according to the formulations set out in Table 1. The inkjet ink formulations were prepared by mixing the components in the given amounts. Amounts are given as weight percentages based on the total weight of the ink.

TABLE 1
Ink formulations

| Component | Ink 1, wt % | Ink 2, wt % |
|---|---|---|
| 3-MPDDA | 51.5 | 47.5 |
| DVE-3 | 23.2 | 3.1 |
| Lauryl acrylate | — | 25.0 |
| UVP6600 | 7.0 | — |
| CN3715LM | — | 5.0 |
| Irgastab UV22 | 0.5 | 0.2 |
| Cyan pigment phthalo blue 15:4 | 3.2 | 3.1 |
| Disperbyk 168 | 1.6 | 1.6 |
| Esacure KIP 160 | 7.0 | 5.0 |
| Omnirad 2959 | 3.0 | — |
| Omnirad 819 | 2.0 | 3.5 |
| Speedcure 7010L | — | 5.0 |
| Byk 307 | 1.0 | 1.0 |
| Total | 100 | 100 |
| Viscosity at 25° C./mPa · s | 13.30 | 10.40 |

3-MPDDA, DVE-3 and lauryl acrylate are monomers, as defined herein. UVP6600 and CN3715LM are amine (meth)acrylate oligomers. Irgastab UV22 is a stabiliser from BASF. Cyan pigment phthalo blue 15:4 is a pigment and is commercially available as Heliogen Blue D7110F. Disperbyk 168 is a polymeric dispersant. Esacure KIP 160 is a photoinitiator manufactured by Lamberti, and Omnirad 2959 and Omnirad 819 (BAPO) are photoinitiators from IGM. Speedcure 7010L is a photoinitiator from Lambson. Byk 307 is a surfactant from Byk.

The viscosity of the inks of Table 1 were measured using a Brookfield DV1 viscometer using the ULA spindle (00) and adaptor connected to a water bath set to 25° C. and rpm 20-30. All of the inks have the required viscosity.

### Example 2

Each of the above ink formulations was printed onto a roll of aseptic packaging material on a web running at 30 m/min using 2×1200 dpi printheads. The resulting ink film was cured by UV irradiation using two IST medium pressure Hg UV lamps, each 145 W/cm operating at full power.

The cured ink film was then rewound and stored as a roll having a diameter of 1150 mm and a width of 214 mm.

Samples from the roll were then taken. Half of these samples were exposed to ebeam radiation having a dose of 43 kGy and the other half of these samples was left untreated.

The treated and untreated cured ink films were then cut to provide circular samples having a diameter of 8 cm and a surface area of 0.5 dm². The migration test cell was constructed from a stainless steel ring (diameter 8 cm, height 2 cm) sandwiched between (i) the circular sample described above (print side up), forming the base of the sandwich and (ii) unprinted substrate that was wrapped in aluminium foil, forming the top of the sandwich. This sandwich was clamped between circular alloy plates connected by three bolts tightened by wing nuts. 15 cm³ of 95% w/w ethanol was measured from a pipette into the cell via a spout welded to the stainless steel ring and the aperture was then sealed shut with a Teflon plug. The sealed cells were stored at 40° C. for 24 hours and then samples of the ethanol were taken and analysed using GC-MS and LC-MS.

The concentrations of the ink components for each cured ink film were determined and the results are set out in Table 2.

TABLE 2
Extraction of migratable species from cured ink films

| | | Concentration of | | Concentration of | |
|---|---|---|---|---|---|
| | | components of ink 1 | | components of ink 2 | |
| | Specific | detected by LC-MS/ppb | | detected by GC-MS/ppb | |
| | migration | No ebeam | With ebeam | No ebeam | With ebeam |
| Component | limit (SML)/ppb | sterilisation | sterilisation | sterilisation | sterilisation |
| 3-MPDDA | 10 | 3.0 | 1.1 | 18.3 | 1.4 |
| DVE-3 | 10 | 31.3 | 1.3 | 2.4 | — |
| Lauryl acrylate | 50 | — | — | 1346.8 | 63.9 |
| UVP6600 | — | — | — | — | — |
| CN3715LM | 10 | — | — | 3.8 | 0.4 |
| Irgastab UV22 | 10 | — | — | — | — |
| Cyan pigment | 60,000 | — | — | — | — |
| phthalo blue 15:4 | | | | | |
| Disperbyk 168 | 10* | 2.6 | 1.3 | 4.4 | 3.9 |
| Esacure KIP 160 | 50 | — | — | — | — |
| Omnirad 2959 | 50 | — | — | — | — |
| Omnirad 819 | 3300 | 0.1 | — | — | — |
| Speedcure 7010L | 10 | — | — | — | — |
| Byk 307 | — | — | — | — | — |

*the lowest SML of the components in the polymeric dispersant

Table 2 shows that for Ink 1, DVE-3 levels of 31.3 ppb were detected in the non-ebeam sterilised sample, which is well above the SML of 10 ppb for DVE-3. This would lead to a compliance failure for food packaging industry standards. Ebeam sterilisation reduces this level to 1.3 ppb, well below the SML.

For Ink 2, the lauryl acrylate level is reduced from 1347 ppb before ebeam sterilisation to 64 ppb after ebeam sterilisation. Although 64 ppb is still above the SML of 50 ppb for lauryl acrylate, the advantage of using ebeam sterilisation to reduce the amount of migratable species in a cured ink film using ebeam sterilisation is still apparent.

Although the other components of Inks 1 and 2 are detected below their SMLs before ebeam sterilisation, Table 2 shows that ebeam sterilisation further reduces the amount of these components.

1. A method of inkjet printing comprising:
(i) providing an inkjet ink comprising a radiation-curable material;
(ii) inkjet printing the inkjet ink onto one or more substrates to produce one or more substrates having a printed surface and an unprinted surface;
(iii) curing the printed surface of the one or more substrates by exposure to a source of actinic radiation and/or a first source of low-energy electron beam radiation;
(iv) storing the one or more substrates such that the printed surface of the one or more substrates is in contact with the unprinted surface of the one or more substrates; and
(v) separating the printed and unprinted surfaces of the one or more substrates and sterilising the one or more substrates by exposure to a second source of low-energy electron beam radiation.

2. The method of claim 1, wherein in step (iv), the one or more substrates is one substrate stored as a roll.

3. The method of claim 2, wherein steps (ii) and (iii) occur as the substrate is caused to move from a substrate reel to a receiving reel.

4. The method of claim 1, wherein in step (iv), the one or more substrates is a plurality of substrates stored as a stack of printed substrates.

5. The method of claim 1, wherein the printed surface of the one or more substrates is cured by exposure to a source of actinic radiation.

6. The method of claim 5, wherein the dose of actinic radiation is greater than 200 mJ/cm²

7. The method of claim 1, wherein the dose provided by the first source of low-energy electron beam radiation is 10-100 kGy.

8. The method of claim 1, wherein the dose provided by the second source of low-energy electron beam radiation is 10-100 kGy.

9. The method of claim 1, wherein the one or more substrates is a food packaging.

10. The method of claim 1, wherein the radiation-curable material comprises a radiation-curable monomer.

11. The method of claim 10, wherein the radiation-curable monomer comprises a di- and/or multifunctional radiation-curable monomer, preferably a difunctional monomer.

12. The method of claim 10, wherein the monomer comprises a (meth)acrylate monomer.

13. The method of claim 1, wherein the radiation-curable material comprises a radiation-curable oligomer.

14. The method of claim 1, wherein the inkjet ink further comprises a colouring agent.

15. A printed substrate for food packaging obtained by the method of claim 1.
